(19) United States
(12) Patent Application Publication
(10) Pub. No.: US 2013/0178474 A1
(43) Pub. Date: Jul. 11, 2013

(54) WATER TREATMENT COMPOSITION CONTAINING HALOGEN-RELEASING COMPOUND AND FLUOROPOLYMER

(71) Applicants: Michael J. Unhoch, Tyrone, GA (US); Nicole Wise, Jonesboro, GA (US); Derek Francis Parish, Peachtree City, GA (US)

(72) Inventors: Michael J. Unhoch, Tyrone, GA (US); Nicole Wise, Jonesboro, GA (US); Derek Francis Parish, Peachtree City, GA (US)

(73) Assignee: Arch Chemicals, Inc., Norwalk, CT (US)

(21) Appl. No.: 13/623,626

(22) Filed: Sep. 20, 2012

Related U.S. Application Data
(60) Provisional application No. 61/536,654, filed on Sep. 20, 2011.

(51) Int. Cl. A01N 25/00

(52) U.S. Cl. CPC A01N 25/00
USPC 514/241

(57) ABSTRACT

The present invention is directed to a water treatment composition, containing 50-99.9 wt. % of particulate halogen-releasing compound; and 0.1-10 wt. % of granular fluoropolymer, wherein all weight percentages are based on the total weight of the composition. The present invention is also directed to a water treatment composition, containing 50-99 wt. % of particulate halogen-releasing compound; 1-10 wt. % of aluminum sulfate; 0.5-15 wt. % of a sulfate salt selected from the group consisting of copper sulfate, zinc sulfate, and combinations thereof; and 0.1-10 wt. % of particulate polytetrafluoroethylene polymer, wherein all weight percentages are based on the total weight of the composition. One particular halogen-releasing compound is trichloroisocyanuric acid.

### CROSS-REFERENCE TO RELATED APPLICATION

This application claims priority under 35 U.S.C §119(e) from U.S. Ser. No. 61/536,654, filed Sep. 20, 2011. The disclosure of U.S. Ser. No. 61/536,654 is incorporated herein by reference in its entirety.

### FIELD OF THE INVENTION

The invention relates to water treatment compositions, and more particularly to slow dissolving water treatment compositions that include at least one halogen-releasing compound and a fluoropolymer.

### BACKGROUND OF THE INVENTION

Chlorine releasing compounds have been used in a wide variety of applications as a sanitizer or disinfectant including in for many applications, including pools and spas, preventing and curing diseases in fisheries, fruits and vegetables preservation, wastewater treatment, algaecide for recycling water of industry and air conditioning, and the like. In some applications, particularly swimming pools and spas, it is desirable to have chlorine to slowly be released into the water. This provides continuous dosing of chlorine to the water. Examples of slow chlorine releasing compounds include chlorinated isocyanuric acids compounds and chlorinated hydantoins.

Trichloroisocyanuric acid (also known as TCCA, “trichlor”, and trichloro-s-triazinetrione) is a widely used chemical sanitizer for many applications. For pools and spas, TCCA is particularly useful because it imparts approximately 90% chlorine to the water, and is therefore easy to use for large pools. In addition, TCCA is stable and can reduce chlorine loss during sun exposure.

One advantage of TCCA in pool and spa applications is that it dissolves slowly in water, allowing for continuous dosing of available chlorine, especially when in tablet form. TCCA tablets dissolve and erode over time when placed in a swimming pool skimmer basket. Erosion is the dominant mechanism when the pool pump is running and dissolution is the primary mechanism when the pool pump is turned off (static dissolution). Due to the continued dissolution of tablet under static conditions, a high concentration of chlorine is built up in the skimmer and plumbing leading to the pump. In addition to the chlorine level, this same water has a low pH and the combination of these two chemical parameters will contribute to bleaching or fading of vinyl pool liners. This condition does not present itself when the pump is running because any chlorine delivered is immediately diluted via circulation into the large body of water in the pool. This condition is further exacerbated when other soluble salts are formulated with the TCCA in the tablet, since the soluble salts tend to increase the rate of dissolution of the TCCA from the tablet. As such, formulated tablets of TCCA dissolve even faster than tablets containing only TCCA, which are also referred to as non-formulated tablets. It would be advantageous if the static dissolution rate could be controlled in order to prevent both high chlorine level and low pH resulting from continued dissolution of the tablet.

Calcium hypochlorite, another sanitizer used in pools and spas, is a rapidly dissolving chlorine sanitizer. Attempts have been made to reduce the dynamic and overall dissolution rate of calcium hypochlorite by adding inert polymers to stick or tablet formulations. For example, U.S. Pat. Nos. 4,865,760; 4,970,020; 5,009,806; and 5,205,961 to PPG Industries all disclose compositions of granular calcium hypochlorite combined with finely divided polyfluorinated polymer, e.g., polytetrafluoroethylene, dispersed throughout the composition. The polyfluorinated polymer functions to, among other things, reduce the dissolution rate of the calcium hypochlorite. However, what remains a need in the art for additional sanitizer compositions with advantageous slow static dissolution rates.

### SUMMARY OF THE INVENTION

In one aspect, the present invention is directed to a water treatment composition, comprising: 50-99.9 wt. % of particulate halogen-releasing compound; and 0.1-10 wt. % of particulate fluoropolymer, wherein the percentages are based on the total weight of the composition.

In one particular embodiment, the invention is directed to a water treatment composition, comprising: 50-99 wt. % of particulate halogen-releasing compound: 1-10 wt. % of sodium hexametaphosphate (SHMP); 1-10 wt. % of aluminum sulfate; 0.5-15 wt. % of a sulfate salt selected from the group consisting of copper sulfate, zinc sulfate, and combinations thereof; and 0.1-10 wt. % of particulate polytetrafluoroethylene polymer, wherein all weight percentages are based on the total weight of the composition.

In another embodiment, the invention is directed to a water treatment composition, comprising: 50-99 wt. % of particulate halogen-releasing compound: 1-10 wt. % of sodium hexametaphosphate; 0.5-15 wt. % of a sulfate salt selected from the group consisting of copper sulfate, zinc sulfate, and combinations thereof; and 0.1-10 wt. % of particulate polytetrafluoroethylene polymer, wherein all weight percentages are based on the total weight of the composition.

These and other aspects will become evident from the following written description of the invention.

### BRIEF DESCRIPTION OF THE FIGURES

FIG. 1 is a graph illustrating percent dissolved per hour of the compositions of the invention;

FIG. 2 is a graph illustrating percent dissolved per hour of the compositions of the invention in a static environment;

FIG. 3 is a graph illustrating percent dissolved per hour of the compositions of the invention in a dynamic environment;

FIG. 4 is a graph illustrating percent dissolved per hour of the compositions of the invention;

FIG. 5 is a graph illustrating percent dissolved per hour of the compositions of the invention in a static environment;

FIG. 6 is a graph illustrating percent dissolved per hour of the compositions of the invention in a dynamic environment;

FIG. 7 is a graph illustrating static dissolution comparison of various compositions of the invention;

FIG. 8 is a graph illustrating dynamic dissolution comparison of various compositions of the invention;

FIG. 9 is a graph illustrating overall dissolution comparison of various compositions of the invention; and

FIG. 10 is a graph illustrating 24-hour dissolution comparison of various compositions of the invention.

### DETAILED DESCRIPTION OF THE INVENTION

It has been discovered that forming a blend of a particulate polyfluorinated polymer and a particulate halogen-releasing compound, and forming a unitary structure from the blend, will provide a unitary structure having a controlled dissolution rate, thus allowing the unitary structure of the blend to last longer and need to be replaced less often. A unitary structure having a slower static dissolution rate has the added benefit of keeping the amount of available chlorine in the skimmer and plumbing lower and pH more neutral which decreases the potential damage of pool skimmers and vinyl liners due to high chlorine levels.

In the present invention, the term “unitary structure” is intended to be a single solid form of the particulate components. Generally, the unitary structure is the blend of components compacted into a single solid structure. Examples of unitary structures include sticks, tablets and other similar structures.

In the present invention, the term “particulate” is intended to be particles in the form of a powder, granules, fibers and mixtures thereof. Particulates may be non-agglomerated or agglomerated.

In the present invention, the term “formulated” means that the composition has additional functional ingredients in addition to the halogen-releasing compound and the fluoropolymer which are designed to treat the pool water. “Non-formulated” means a composition which only contains the halogen-releasing compound and the fluoropolymer and is free of other functional ingredients intended to treat the pool water.

As indicated above, the invention is a water treatment composition, comprising: 50-99.9 wt. % of a particulate halogen-releasing compound; and 0.1-10 wt. % of particulate fluoropolymer, wherein all weight percentages are based on the total weight of the composition. Each of these components is described in more detail below.

The first component of the invention is a halogen-releasing compound. Suitable halogen-releasing compounds include chlorinated isocyanuric acids, such as, trichloroisocyanuric acid (TCCA), and dichloroisocyanuric acid (DCCA), for example, and halogen-containing hydantoins, including both chlorine-containing hydantoins and bromine-containing hydantoins such as bromochlorodimethylhydantoin (BCDMH); dibromodimethylhydantoin (DBMH), dichlorodimethylhydantoin (DCDMH), dichloromethylethylhydantoin (DCMEH), and the like. Of these compounds, trichloroisocyanuric acid, also known as TCCA, “trichlor”, and trichloro-s-triazinetrione, is of particular interest.

Generally, the halogen-releasing compound is present in the composition in an amount from 50-99.9% by weight of the composition. When the composition is to be used to prepare a non-formulated unitary structure, the halogen-releasing compound is generally present in higher amounts. Typically, in a non-formulated composition, the halogen-releasing compound is present in an amount from about 90-99.9% by weight of the composition, and generally from about 96% to about 99.5% by weight of the composition. When the composition is to be used as a formulated composition, the halogen-releasing compound is present in lesser amounts. The halogen-releasing compound then typically present in an amount between about 60% and about 99% by weight of the composition, more typically in amount between about 70% and about 98% by weight of the composition and most typically between about 90% and about 96% by weight of the composition. All weight percentages are based on the total weight of all of the components of the composition. Typically, the halogen-releasing compound is present as a particulate material.

The second component of the invention is a particulate polyfluorinated polymeric material or fluoropolymer. Examples of polyfluorinated polymeric materials that may be used as the compaction aid include: polytetrafluoroethylene (PTFE), polychlorotrifluoroethylene, polyhexafluoropropylene, copolymers of chlorotrifluoroethylene and ethylene, copolymers of ethylene and tetrafluoroethylene, copolymers of hexafluoropropylene and tetrafluoroethylene, copolymers of vinylidene fluoride with tetrafluoroethylene, hexafluoropropylene, chlorotrifluoroethylene or pentafluoropropylene, and terpolymers of vinylidene fluoride, hexafluoropropylene and tetrafluoroethylene. Other fluoropolymers derived from fluoroalkyl acrylates, such as poly(1,1-dihydroperfluorobutyl acrylate), poly(3-perfluoromethoxy-1,1-dihydroperfluoropropyl acrylate), poly(trifluoroisopropyl methacrylate) and the condensation product of adipic acid and 2,2,3,3,4,4-hexafluoropentanediol may also be used. The polyfluorinated polymer may be added to the particulate halogen-releasing compound as a particulate material, such as a finely-divided dry powder, granules, fibrous material and the like. Polytetrafluoroethylene (PTFE) has been found to be effective in the present invention. The particulate fluoropolymer is present in the composition in an amount of 0.1-10% by weight, generally in an amount between about 0.2% and about 7.5% and typically between about 0.25% and about 5.0% by weight of the blend. In a particular embodiment, the fluoropolymer is present in an amount between about 0.5% and about 2.0% by weight in the blend all weight percentages being based on the total weight of the composition.

Suitable commercially available polytetrafluoroethylene (PTFE) useable in the present invention include Zonyl® MP1200, available commercially from DuPont (Wilmington, Del.), Peflu available from M F Cachet, and DougYue F16A, available from ShanDong DougYue Polymer Material, LTD, Shandong, China. The PTFE may be essentially non-agglomerated, as is the Zonyl® MP 1200 or may be agglomerated, as is the DongYue DF16A. One particularly preferred fluoropolymer is Zonyl® MP1200, available commercially from DuPont (Wilmington, Del.). Generally, the particulate fluoropolymer has particles having a particle size in the range of about 1.0 to about 15 micron with an average particle in the 3 to 5 micron range. When the fluoropolymer is agglomerated, there are more than about 50% of particles are packed together to form particle agglomerations having a particle agglomeration size in the 10-50 micron range. Analysis of the DongYue DF 16A found the particles are particles having a size between about 1 micron and 15 microns and particle agglomerations in the range of about 10-40 microns in size. In contrast, the essentially non-agglomerated Zonyl® MP 1200 contained mostly loose particles having a particle size in the range of about 1-10 microns, and very few agglomerations in the range of 10-15 microns in size.

Additional ingredients may also be included in the composition of the invention. In one embodiment, additional water-treatment chemicals such as aluminum sulfate salt, copper sulfate salt, zinc oxide, and zinc sulfate salt may be added to the composition individually or in any combination. Further additional water treatment chemicals include sequestering agents such as citric acid, sodium hexametaphosphate, and the like, phosphate reducers, polymeric clarifiers, dichlor, cyanuric acid, and the like. In one embodiment, the composition of the invention includes 1-10 wt. % of aluminum sulfate, and more typically 0.2-4 wt. % of aluminum sulfate, based on the total weight of the composition. In another embodiment, the composition of the invention may include 0.5-15 wt. %, and more typically 1-4 wt. % of copper sulfate, zinc sulfate, or a combination thereof, based on the total weight of the composition. The composition of the invention may also include up to about 3 wt. % of cyanuric acid, based on the total weight of the composition.

The components of the composition can be dry blended or spray coated and compacted into a unitary structure of a desired shape and/or size. Exemplary shapes include, for example, a stick, a tablet, a pellet, a briquette, a brick and the like. The size of the unitary structure is generally selected for the preferred end use. For example, if the unitary structure is intended to be used in a pool skimmer, the size and the shape should be such that it easily fits in a typical pool skimmer. Alternatively if the unitary structure is to be placed in an in-line or off-line erosion feeder, or other structure such as a floater, again the size and shape for the unitary structure should be appropriate for its end use. The unitary structure can generally weigh up to 300 grams or more, again depending on its intended end use. Generally, the unitary structure of the composition will be around 200-250 grams.

In addition to providing a slower rate of dissolution, the fluoropolymer may also provide and advantage in forming the unitary structure from the composition. The fluoropolymer may alleviate the need or a mold release, such as boric acid, from being compounded with the composition of the present invention. That is, the fluoropolymer may provide mold release properties to the unitary structure. Alternatively, a mold release agent may additionally be added to the composition to aid in the release of the unitary structure from the mold used to shape and form the composition into a unitary structure. Boric acid is generally used as the mold release agent, and is it typically added in an amount up to 5% by weight. Typically boric acid will be added in an amount around 0.25% to 0.75% by weight.

To form a unitary structure, the components of the composition are blended together using known techniques, such as a paddle blender and the like, to form an essentially homogenous mixture. Once the components are mixed, a portion of the components are placed in a die and compressed with sufficient pressure such that the mixture of components of the composition are brought together and form a unitary structure.

A more complete understanding of the present invention can be obtained by referring to the following illustrative examples of the practice of the invention, which examples are not intended, however, to limit the invention.

### EXAMPLES

### Example 1

Various 30 gram (g) sticks, labeled as Samples A-G were formed using the process described below containing the composition shown in Table 1.

TABLE 1
Formulations

| | | | Copper | Aluminum | |
|---|---|---|---|---|---|
| Sample | TCCA | PFTE | Sulfate | Sulfate | Zinc Sulfate |
| A | 30 g | — | — | — | — |
| B | 29.40 g | 0.6 g | — | — | — |
| C | 29.475 g | 0.525 g | — | — | — |
| D | 28.05 g | — | 0.45 g | 1.5 g | — |
| E | 28.05 g | 0.6 g | 0.45 g | 0.9 g | — |
| F | 28.32 g | 0.6 g | — | 0.18 g | 0.9 g |
| G | 28.32 g | 0.525 g | — | 0.255 g | 0.9 g |

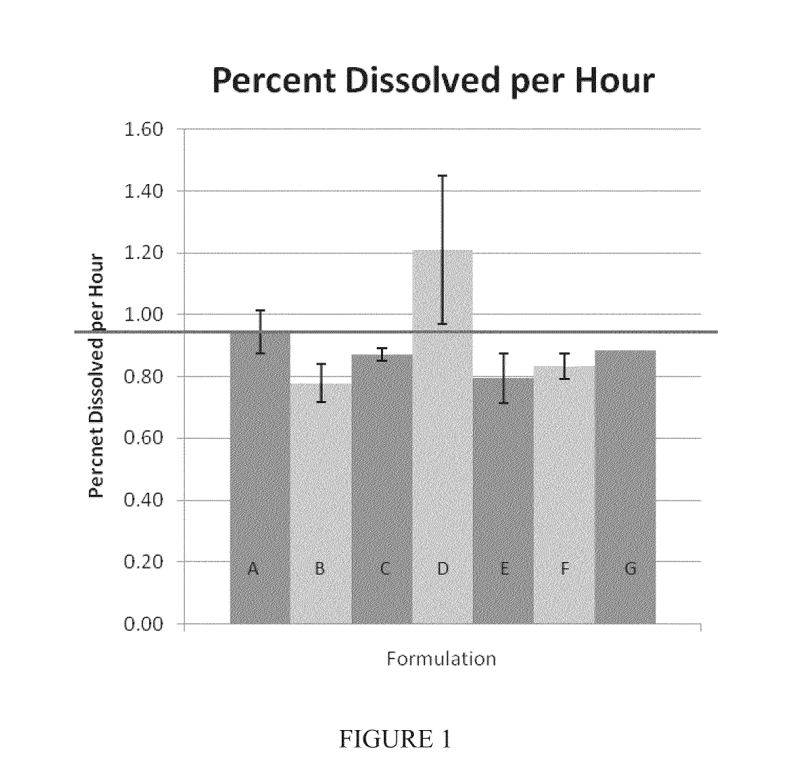

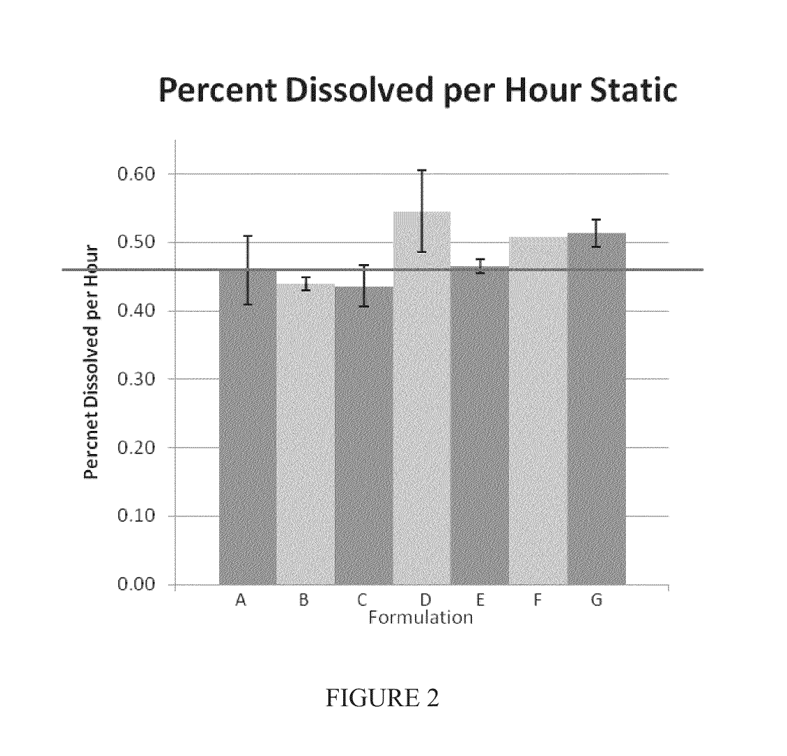

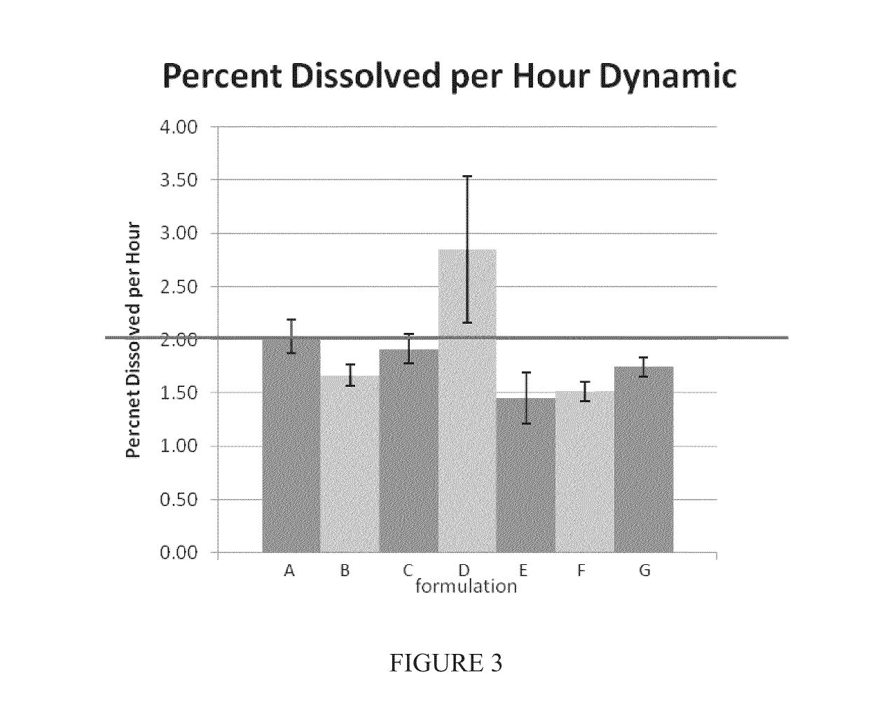

Each of the samples, except Sample A, were blended by adding the components in the amounts listed to a HDPE bottle and inverting and rolling for a minimum of 60 seconds (sec) to produce 30 g compositions. Once blended, mixed components were poured into a die, the punch was added and a stick was pressed. Samples B, E and F each contain 2 wt. %. PTFE and Samples C and G contain 1.75 wt. % PTFE. Samples A and D do not contain PTFE and are Comparative Examples. Once the compositions were pressed the weight, length, and diameter were measured. Density of each stick was required to be within +/−0.2 of 1.75 grams per centimer³ (g/cm³). After meeting density requirements the stick was tested in dissolution rate testing. Sticks were placed in water for 30 min, removed and wet weight was measured. After recording the weight, the sticks were placed into skimmer baskets inside of 10 gallon tanks that contained a heater (set to 80-85° F.) and a filter was run for 7 hours a day to simulate pool operation. The skimmer basket was connected to the pump so that the water flowed over the stick when the filter was running. Sticks were weighed daily before starting filter and after stopping filter, giving weights for static and dynamic periods. Percent dissolution was calculated for each day and for each static and dynamic cycle. FIG. 1 shows the average dissolution rate per hour of each of the sticks. FIGS. 2 and 3 show the static and dynamic dissolution rates of the formulations. All values on charts represent averages of each stick, since all formulations were tested at least twice.

The data in FIGS. 1-3 show the effect of the polytetrafluoroethylene polymer on the overall, static and dynamic dissolution rates for TCCA and TCCA formulations with copper and zinc salts. The effect was more pronounced for the dynamic dissolution rate than the static, but nonetheless was present for both conditions.

### Example 2

Trichlor tablets were prepared using PTFE (Teflon) and cyanuric acid (CYA) to slow the dissolution rate. Components were weighed out, in the amounts shown in Table 2.

TABLE 2
Formulations

| Sample | TCCA | PTFE | CYA |
|---|---|---|---|
| H | 30 g | — | — |
| I | 29.55 g | 0.45 g | — |
| J | 29.475 g | 0.525 g | — |
| K | 28.95 g | 0.45 g | 0.6 g |
| L | 29.1 g | 0.3 g | 0.06 g |
| M | 29.025 g | 0.375 g | 0.6 g |
| N | 28.8 g | 0.3 g | 0.9 g |
| O | 28.35 g | 0.45 g | 1.2 g |
| P | 28.275 g | 0.525 g | 1.2 g |

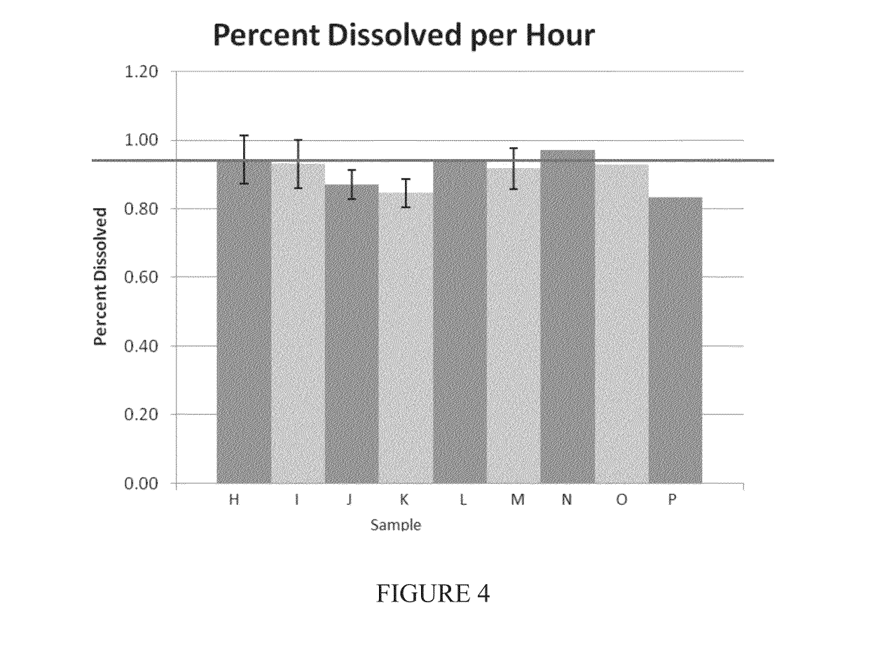

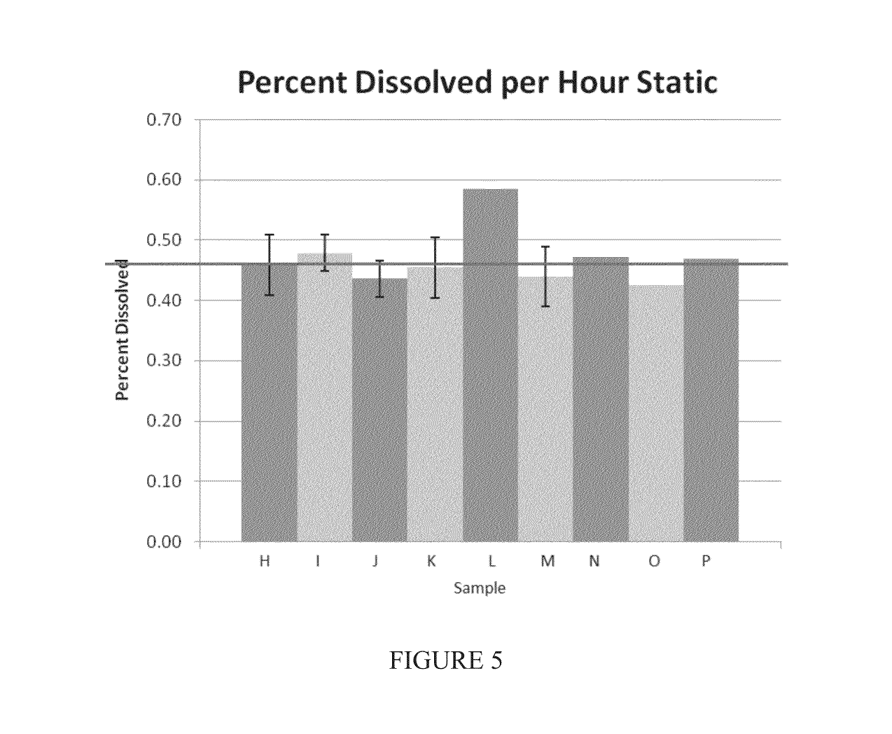

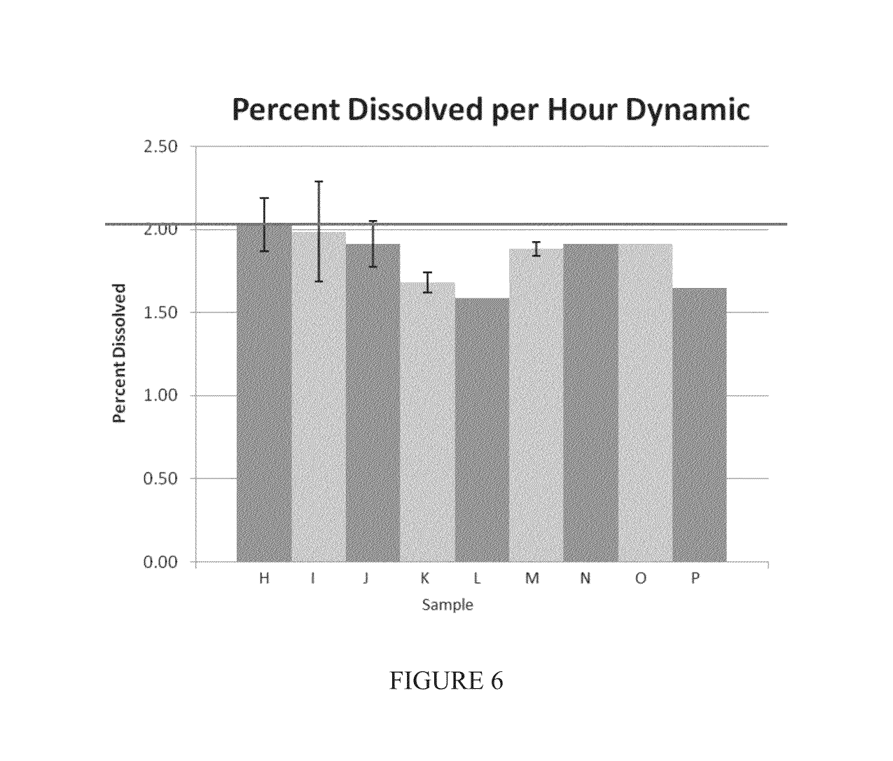

Each composition shown in Table 2 is blended to make 30 g blended compositions as described in Example 1, and pressed into sticks, as described in Example 1. After initial weights and wet weights were taken, the dissolution rate of the sticks was determined using the same tank set up as in Example 1. The weights of the sticks were recorded prior to starting the filter and after the filter was turned off, giving overall, static, and dynamic dissolution rates. Different levels of PTFE and cyanuric acid were blended with one another and tested for dissolution rate. The dissolution rates are shown in FIGS. 4, 5, and 6. FIG. 4 shows the average dissolution rate per day for each stick, and FIGS. 5 and 6 show the static and dynamic dissolution rates. These data show that overall, dynamic and static dissolution is affected by the addition of cyanuric acid and PTFE at almost all levels. The ideal levels of PTFE on and cyanuric acid are found to be 1.5% PTFE and 2% cyanuric acid. This example shows that cyanuric acid may be added to a stick/tablet in combination with PTFE in order to slow the dissolution of the stick product.

### Example 3

Various Formulations were tested for static, dynamic, and overall dissolution rates. The tested formulations include the following compositions:

Sample Q is prepared from a blend 98.0 wt. % TCCA and 2 wt. % PTFE;

Sample R is prepared from a blend 98.25 wt. % TCCA+1.75 wt. % PTFE;

Sample S is prepared from a blend containing 98.5 wt. % TCCA+1.5 wt. % PTFE;

Sample T which is Silk Smart Sticks® from BioGuard® (TCCA and glycoluril as described in U.S. Pat. Nos. 5,888,939 and 5,670,451) (comparative example); and

Sample U is 100 wt. % TCCA (comparative example).

Each of the Samples Q, R, S and U are made into stick having a weight of about 230 g each, using the process as described in Example 1. Each of the Samples were dissolution tested, where each of the Samples were tested in different pools in order to minimize the influence the pool may have on dissolution rates and to give more representative numbers.

This series of tests utilized 5,000-10,000 gallon pools, with pumps, filters and heaters running 8 hours (dynamic dissolution) and left off for 16 hours (static dissolution) each day. Electronic flow meters were placed on pools to ensure the flow of each was consistent with the one another. The target flow rate for each pool was 30 gallons per minutes (gpm). Heaters were set to 85°+/−5° C. The number of replicates, average temperatures and flow rates for each stick are listed in Table 3.

TABLE 3

| | | Average | Average |
|---|---|---|---|
| | Replications | Temperature | Flow Rate |
| TCCA Stick | 3 | 81.34 +/− 2.74 | 30.57 +/− 0.55 |
| 1.5% PTFE Stick | 2 | 81.78 +/− 1.52 | 30.71 +/− 0.24 |
| 1.75% PTFE Stick | 6 | 83.91 +/− 1.65 | 31.13 +/− 1.72 |
| 2% PTFE Stick | 2 | 80.93 +/− 3.92 | 30.78 +/− 0.34 |
| BioGuard ® Silk | 4 | 83.77 +/− 1.79 | 30.77 +/− 0.41 |
| Smart Sticks ® | | | |

The water was balanced and each of the sticks were placed into skimmer baskets of the designated pool, and static and dynamic dissolution rates were measured after 16 hour period and 8 hour period, respectively. The total dissolution rate was calculated by combining the two dissolution rates.

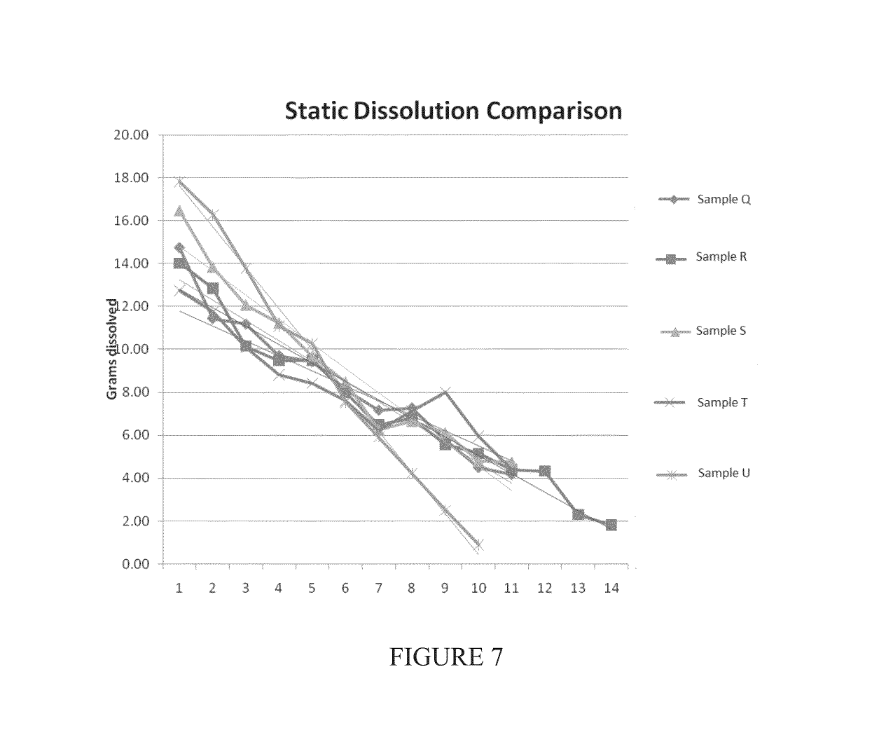

FIG. 7 shows a comparison of each of the formulations static dissolution rates over 10 days (1.75 wt. % PTFE has data for up to 14 days since more sticks were tested). FIG. 7 illustrates that addition of PTFE slows the static dissolution of 100 wt. % trichlor. FIG. 7 also illustrates that static dissolution rates of the sticks containing PTFE are very similar to the static dissolution rate of the BioGuard® Silk Smart Sticks®; based on the slopes of each line.

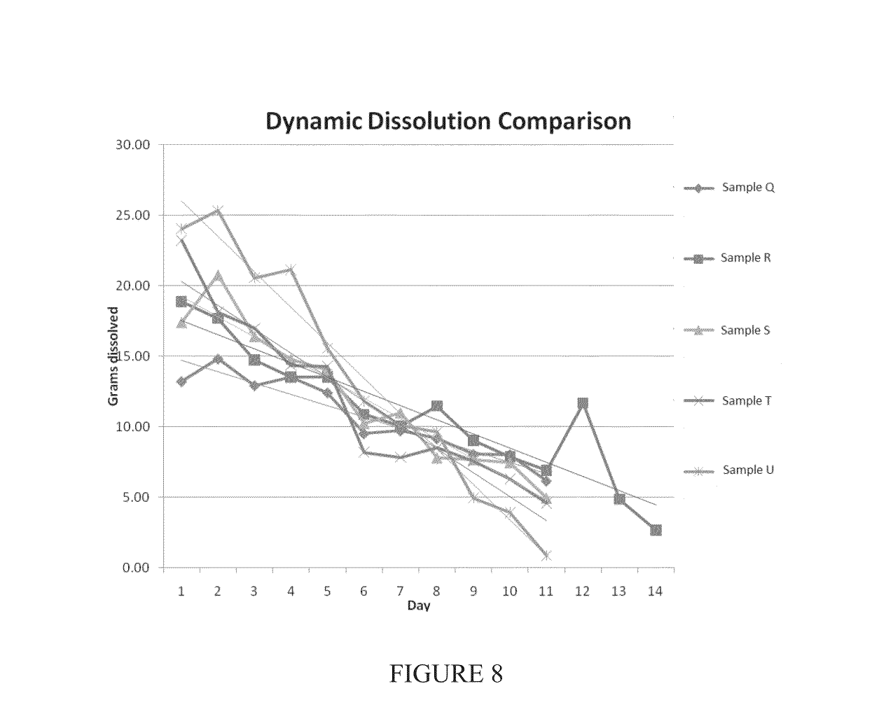

The dynamic dissolution rate of each formulation is compared in FIG. 8. FIG. 8 shows that the PTFE is also successful at significantly reducing the dynamic dissolution rate of the trichlor.

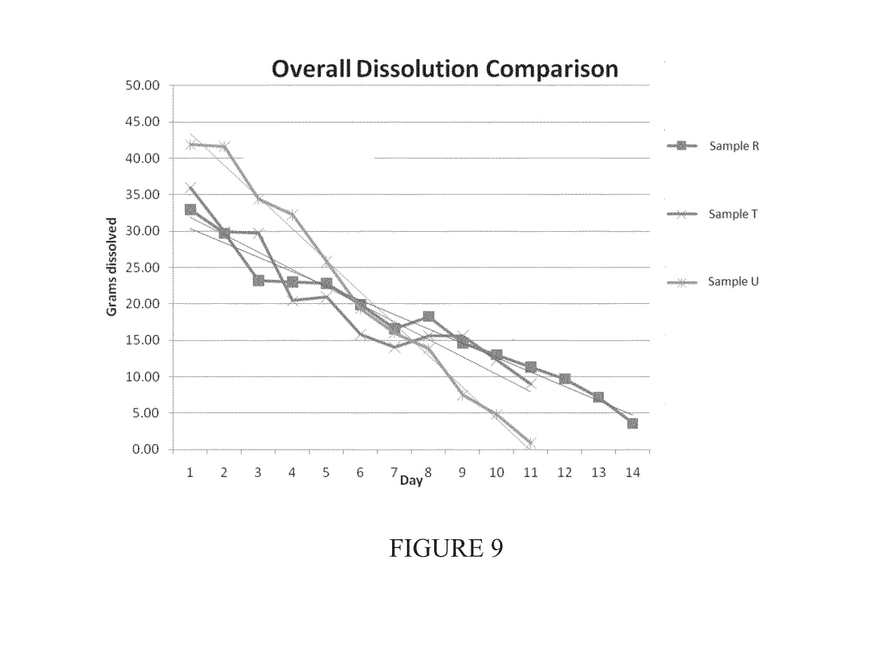

FIG. 9 shows a comparison of the overall dissolution rates of Samples R, T and U. This comparison shows that the addition of PTFE slows the overall dissolution of the trichlor to a level that is near that of the Silk Smart Sticks®.

Based on testing in skimmers, it was found that the straight TCCA sticks last for about 11 days before completely dissolved, and the Silk Smart Sticks®, and 1.75 wt. % PTFE sticks last about 16 days before dissolved. These data were found in a 5,000 gallon pool, 1 stick per skimmer, average temperature in a range of 80-85° F., and pump running 8 hours a day.

### Example 4

In this Example, the 24-hour dissolution rate was tested. Test utilized 5,000-10,000 gallon pools with pumps, filters and heaters running 24 hours a day. Electronic flow meters were placed on pools to ensure the flow of each was consistent with the one another. The target flow rate for each pool was 30 gpm. Heaters were set to 85°+/−5° C. Each run was conducted until sticks were completely dissolved. The water was balanced and each of the sticks was placed into skimmer baskets of the designated pool. The sticks were weighed once daily. The average temperatures and flow rates for each stick are listed in Table 4.

TABLE 4

| | Average Temperature | Average Flow Rate |
|---|---|---|
| 1.75% PTFE Stick | 85.23 +/− 3.35 | 30.95 +/− 1.01 |
| Silk Smart Sticks ® | 86.28 +/− 2.85 | 30.59 +/− 0.32 |
| 1.75% PTFE Stick (bagged) | 87.7 +/− 1.57 | 31.26 +/− 0.36 |

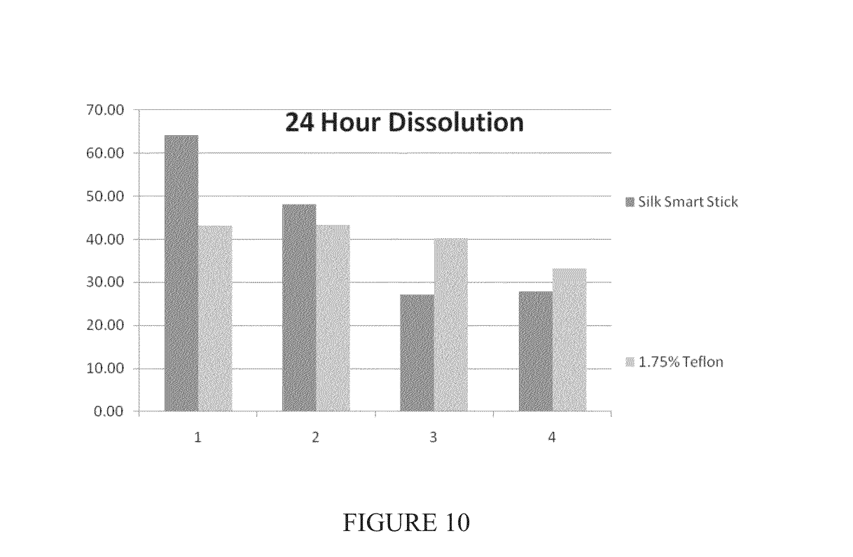

The results in FIG. 10 show that the 1.75 wt. % PTFE stick has a constant rate of dissolution over the week. It was found that the Silk Smart Sticks® lasted about 8 days before completely dissolving, whereas, the 1.75 wt. % about 10 days before becoming completely dissolved. It is believed that the PTFE slows the dynamic dissolution of TCCA better than the Silk Smart Sticks® formulation.

### Example 5

Various Formulations were tested for time for a stick to dissolve in a pool skimmer. The tested formulations include the following compositions:

Sample V is prepared from a blend 99.0 wt. % TCCA and 1 wt. % PTFE DF16A available from DongYue;

Sample W is prepared from a blend 98.75 wt. % TCCA+1.25 wt. % PTFE DF16A available from DongYue; and

Sample X is prepared from a blend containing 100 wt. % TCCA (comparative example).

Each of the Samples V, W, and X are made into stick having a weight of about 230 g each, using the process as described in Example 1. Each of the Samples were dissolution tested, where each of the Samples were tested in different pools in order to minimize the influence the pool may have on dissolution rates and to give more representative numbers. The process of example 3 was repeated to obtain 8 hour pump time run and 16 hours of static dissolution and the process of example 4 was repeated to obtain 24 hour pump run data to determine the time needed to dissolve the sticks. 23 tablets for each sample were tested and the average number of days for the sticks to dissolve are shown in Table 5.

TABLE 5
Average Days To Stick Dissolved

| | 8 hour/day pump run | 24 hour/day pump run |
|---|---|---|
| Sample V | 10.25 days | 9.14 days |
| Sample W | 8.6 days | 8.71 days |
| Sample X | 5 days | 5 days |

While the invention has been described above with references to specific embodiments thereof, it is apparent that many changes, modifications and variations can be made without departing from the invention concept disclosed herein. Accordingly, it is intended to embrace all such changes, modifications, and variations that fall within the spirit and broad scope of the appended claims.

What is claimed is:

1. A water treatment composition, comprising:
50-99.9 wt. % of a particulate halogen-releasing compound, said halogen-releasing compound comprising a compound selected from the group consisting of chlorinated isocyanuric acids, chlorine containing hydantoins, bromine-containing hydantoins and mixtures thereof; and
0.1-10 wt. % of particulate fluoropolymer,
wherein all weight percentages are based on the total weight of said composition.

2. The water treatment composition according to claim 1, wherein the halogen-releasing compound comprises particulate trichloroisocyanuric acid.

3. The water treatment composition according to claim 2, wherein said particulate trichloroisocyanuric acid comprises from about 90 wt. % to about 96 wt. %, based on the total weight of the composition.

4. The water treatment composition according to claim 1, wherein said fluoropolymer is polytetrafluoroethylene polymer.

5. The water treatment composition according to claim 1, wherein said fluoropolymer is present in an amount between about 0.25 wt. % and about 5.0 wt. %, based on the total weight of the composition.

6. The water treatment composition according to claim 5, wherein said fluoropolymer is present in an amount between about 0.75 wt. % and about 2.0 wt. %, based on the total weight of the composition.

7. The water treatment composition according to claim 1, further comprising 1-10 wt. % of aluminum sulfate, based on the total weight of the composition.

8. The water treatment composition according to claim 7, further comprising 0.2-4 wt. % of aluminum sulfate, based on the total weight of the composition.

9. The water treatment composition according to claim 1, further comprising 0.5-15 wt. % of a sulfate salt selected from the group consisting of copper sulfate, zinc sulfate, and combinations thereof, based on the total weight of the composition.

10. The water treatment composition according to claim 9, wherein said sulfate salt is present in an about between 1 wt. % and 4 wt. %, based on the total weight of the composition

11. The water treatment composition according to claim 1, further comprising cyanuric acid, and the cyanuric acid is present in an amount up to about 3 wt. % of cyanuric acid, based on the total weight of the composition.

12. The water treatment composition according to claim 1, wherein said composition is in the form of a unitary structure.

13. The water treatment composition according to claim 1, wherein said composition further comprises zinc oxide, citric acid, boric acid, sodium hexametaphosphate, phosphate reducers, polymeric clarifiers, dichlor, cyanuric acid, boric acid and combinations thereof.

14. The water treatment composition according to claim 1, further comprising
1-10 wt. % of aluminum sulfate; and
0.5-15 wt. % of a sulfate salt selected from the group consisting of copper sulfate, zinc sulfate, and combinations thereof;
all weight percent are based on the total weight of said composition.

15. The water treatment composition according to claim 13, wherein said halogen-releasing compound comprises particulate trichloroisocyanuric acid, and the trichloroisocyanuric acid comprises from about 90 wt. % to about 96 wt. %, based on the total weight of the composition.

16. The water treatment composition according to claim 14, wherein said fluoropolymer is present in an amount between about 0.25 wt. % and about 5.0 wt. %, based on the total weight of the composition.

17. The water treatment composition according to claim 16, wherein said fluoropolymer is present in an amount between about 0.5 wt. % and about 2.0 wt. %, based on the total weight of the composition.

18. The water treatment composition according to claim 14, wherein said aluminum sulfate is present between about 0.2 wt. % and about 4 wt. %, and said sulfate salt comprises from about 1 wt. % and about 4 wt. % based on the total weight of the composition.

19. The water treatment composition according to claim 14, further comprising cyanuric acid, and the cyanuric acid is present in an amount up to 3 wt. % of cyanuric acid, based on the total weight of the composition.

20. The water treatment composition according to claim 14, wherein said composition is the form of a unitary solid.

21. The water treatment composition according to claim 14, wherein said composition further comprises zinc oxide, citric acid, boric acid, sodium hexametaphosphate, phosphate reducers, polymeric clarifiers, dichlor, cyanuric acid, and combinations thereof.

22. The water treatment composition according to claim 14, further comprising 1-10 wt. % of sodium hexametaphosphate (SHMP), based on the total weight of said composition.

23. The water treatment composition according to claim 1, further comprising 1-10 wt. % of sodium hexametaphosphate (SHMP) and 0.5-15 wt. % of a sulfate salt selected from the group consisting of copper sulfate, zinc sulfate, and combinations thereof; based on the total weight of said composition.

24. The water treatment composition according to claim 1, wherein the fluoropolymer is in the form of agglomerated particles.

25. The water treatment composition according to claim 1, wherein the fluoropolymer is in the form of essentially non-agglomerated particles.

26. The water treatment composition according to claim 1, wherein the halogen-releasing compound comprises a mixture of particulate trichloroisocyanuric acid and a halogen containing hydantoin.
